(19) United States
(12) Patent Application Publication
(10) Pub. No.: US 2007/0125324 A1
(43) Pub. Date: Jun. 7, 2007

(54) METHOD OF LUBRICATING AN INTERNAL COMBUSTION ENGINE

(76) Inventor: Rodney Alexander Houston, Hillarys (AU)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/562,178

(22) Filed: Nov. 21, 2006

(30) Foreign Application Priority Data
Nov. 22, 2005 (AU) 2005906468

(51) Int. Cl. F01M 3/00; F02B 33/04; F02B 43/00

(52) U.S. Cl. 123/73 AD; 123/73 C; 123/1 A

(57) ABSTRACT

The invention provides a method for lubricating a two stroke cycle fuel injected internal combustion engine of petroil type. A port or manifold injection system and a direct injection system form part of the engine. Fuel and oil are pre-mixed and supplied to the port or manifold injection system for a port or manifold injector to deliver lubricant to the crankcase of the engine. The method allows lubrication of engine components in accordance with engine operating conditions.

### CROSS-REFERENCE TO RELATED APPLICATIONS

This application claims priority to Australian Patent Application Serial No. 2005906468, entitled “A Method of Lubricating an Internal Combustion Engine,” filed Nov. 22, 2005, which is incorporated herein by reference in its entirety.

### BACKGROUND

This invention relates to lubrication of two stroke internal combustion engines employing port injection systems for delivery of fuel to an engine.

Port injection systems are often employed in internal combustion engines including those operated on the two stroke cycle. Port injection systems involve fuel injection into an intake manifold or inlet port of the engine, with port injector(s) delivering fuel from a fuel supply system into each inlet port of the engine. Single or multi-point port injection may be employed. Port fuel injection, because of the relatively large window of timings available for fuel injection, are well adapted to providing the wide range of fuelling required from idle conditions to maximum power conditions (which for high performance engines can be a relatively wide range). However port fuel injection systems, particularly in 2-stroke engines employing piston controlled exhaust ports, suffer from poor fuel economy due to what is commonly referred to as short-circuiting of the air-fuel charge. These engines also tend to suffer from poor exhaust emissions. For some applications, such as motocross competition, there is also a desire to increase the responsiveness of these engines.

To overcome some of these deficiencies, direct fuel injection has been developed and successfully applied to these engines. Direct fuel injection engines, in particular when operating with a stratified charge, offer increased combustion stability over port injected engines. However it has been found that for high performance engines, it has been a challenge to economically provide a direct fuel injection system that has the required turn-down ratio to control and deliver fuel from idle conditions right through to high power conditions. One way to overcome this in high performance engines may therefore be direct injected (or DI) with port injection by the port injection (or PI) system augmenting the DI system to provide such additional power and torque. Such augmentation may be achieved by operation of the PI system especially under high speed-high load operating conditions while the DI system is operated under other engine operating conditions, particularly low engine speed—low engine load conditions. Thus, at lower speeds and loads, the DI system provides emissions control/driveability and fuel efficiency benefits whilst at high engine speeds and loads, the PI system either complements or acts as the complete fuel source, thus effectively increasing the turn down ratio of the system. Such an engine is described in U.S. Pat. No. 5,092,287, the contents of which are hereby incorporated herein by reference.

Lubrication of such engines is important. To achieve this, two stroke cycle engines are typically provided with an independent oil reservoir, with an associated pump and metering device arranged to deliver oil at a regulated rate to the fuel and/or air introduced to the engine whilst in operation.

In high performance vehicles, like high performance motorcycles and high performance watercraft, weight of an engine must, if possible, be maintained at a minimum. Such engines, however, still require lubrication. In such engines, lubricant or oil is supplied from the oil reservoir and pumped by an oil pump or other oil metering devices to the engine components requiring lubrication. These accessory systems add weight to the engine. They also add complexity, and potentially a more expensive control system. The accessory systems also have a cost.

For example, WO 89/09326 in the name of Brunswick Corporation discloses an oil injection system provided for a two cycle crankcase compression internal combustion engine. A crankcase pressure driven oil pump draws oil from an oil source and delivers pumped oil through an oil output line to the fuel supply system. A solenoid valve in the oil output line controls the flow of pumped oil to the fuel supply system.

U.S. Pat. No. 5,941,745 discloses a fuel and lubricant supply for an engine used to power an outboard motor of a watercraft. The lubricant supply delivers lubricant through a delivery mechanism for delivering lubricant. The lubricant supply comprises a first oil tank, an oil supply pipe and an oil pump. The oil pump draws oil through an intake pipe and an oil filter placed therealong and delivers it to a second oil tank in a motor near the engine.

It is an object of the present invention to attain further reduction in engine weight in a port injected engine, particularly for those port injected engines to be used in high performance vehicles.

### SUMMARY

With this object in view, the present invention provides a method of lubricating a two stroke cycle fuel injected internal combustion engine, particularly a crankcase scavenged engine, having a port injection system for providing a fuel to said engine and comprising the steps of: pre-mixing a lubricant with fuel to form a fuel/lubricant mixture, supplying the fuel/lubricant mixture to said port injection system having a port injector and controlling operation of said port injector to deliver a fuel/lubricant mixture to the crankcase of said engine for lubricating engine components in accordance with engine operating conditions. In such manner, the weight and complexity of the engine may be reduced by dispensing with the requirement for a discrete lubricating system. Specifically, separate lubricant pump and tank may be avoided with advantage in weight reduction.

Lubricant and fuel pre-mixed in desired ratio are introduced to the fuel tank during fuelling of the engine. The ratio of fuel to lubricant may be within the range of approximately 25:1 to 100:1. Additional additives may also be incorporated.

It is to be noted that, contrary to conventional practice, lubricant such as oil is not, and cannot be, metered to create variable ratio with fuel due to the lack of a separate oil pump or oil metering device.

The PI injection events, delivering the fuel oil mixture to the crankcase of the engine in a crankcase scavenged engine provides lubricant to the crankcase, allowing lubricant requirements to be met. The port injection system may be a stand alone system.

The engine advantageously includes a direct fuel injection system. Direct fuel injection offers benefits, in terms of combustion stability, over port injected systems over at least some portion, preferably the low speed, low load range, of the engine operating range. An embodiment in which the engine is operated in spark ignited, stratified charge, lean burn combustion mode, under certain engine operating conditions is particularly preferred. Fuel may be directly injected alone or entrained in air, in admixture, if desired, with other components such as combustion enhancers. The Applicant has developed various direct fuel injection strategies—involving fuel injectors for dual fluid injection such as air/fuel injection—as disclosed, for example, in U.S. Pat. Nos. 4,693,224 and Re 36768, the contents of which are hereby incorporated by reference. However, the present invention is not limited in its application to engines incorporating a direct dual fluid injection system.

The method of the invention is particularly suitable for any engine incorporating both PI and DI fuel injection systems, where the PI system is applied to augment a direct injection system in high performance or very high performance vehicles, such as high performance and very high performance motor cycles.

While, in a PI/DI engine, the port injection (PI) system is operated under selected engine operating conditions, particularly high engine speed—engine load conditions, its role in providing lubrication may, and likely will, require the PI system to be operated under other engine operating conditions outside the high engine speed—high engine load region. Such operation may be intermittent or periodic, the periodicity being set by an Engine Control Unit (or ECU) in response to sensed engine conditions. For example, the PI system may be operated under low engine speed—low engine load conditions with the objective of lubrication. In this case, operation is not due to fuelling requirement/turn-down ratio issues, but rather to provide acceptable lubrication in accordance with a lubrication target or schedule set by the ECU in accordance with actual or anticipated engine operating conditions.

For example, when the engine has been operating in a DI mode at low load/low speed conditions for a period of time, it may be necessary to provide an amount of lubrication through the PI system. Since operation of the PI system will inherently provide additional fuelling, the ECU will compensate by adjusting the operation of the DI system so that the overall effect, at least as far as the operator is concerned, is as transparent as possible, and no perceptible difference in engine speed or power is observed.

The PI system can also be operated to augment the DI system under high engine speed—high engine load conditions in the case of high performance vehicle such as a motorcycle.

In this case too, a relationship may be established by the ECU between scheduling of the PI injection events and DI injection events. The ECU may also control the profile, timing, duration and/or frequency of PI and DI injection events in accordance with engine operating conditions. Such ECU control and output of an appropriate schedule of PI and DI fuel injection events, and associated metering events, is achieved having regard to fuelling, combustion efficiency and lubrication requirements of the engine.

The ECU may also regulate the quantity of fuel metered to and/or apportioned between the PI and DI injectors, as well as the quantity of fuel delivered to the combustion chamber(s) of the engine, in such a way that correct fuelling of the engine is achieved in tandem with desirable lubrication requirements, and desired engine performance. For example, if the PI system is operated under low engine speed- low engine load conditions to achieve appropriate lubrication, the quantity of fuel delivered by the direct injector(s) in fuel injection event(s), typically employed under such conditions, may be reduced or even eliminated accordingly to avoid over-fuelling or rich misfire. DI injection events may be delayed or cancelled for the same reason.

PI and DI injection events are scheduled and controlled, for example by controlling timing and duration of these events, by the ECU to avoid over-fuelling and rich misfire of the engine. PI injection events may be scheduled to replace DI injection events. Such PI injection events may be modified in profile, duration and frequency if required to compensate for the loss of DI injection event(s) while maintaining combustion efficiency. The ECU outputs an appropriate schedule of PI and DI injection events for given engine operating conditions. Scheduling of PI events for lubrication occurs according to a schedule of lubrication events maintained or set by the ECU.

Conveniently, a common fuel pump may supply both the PI and DI fuel injection systems. The DI system may require a higher fuel pressure supply than the PI system. Fuel pressure regulators may be used to ensure that the appropriate fuel pressures are supplied to each of the PI and DI fuel injection systems.

Alternatively, the PI and DI fuel injection systems may be adapted to operate at a common fuel supply pressure.

An engine control unit (ECU) with such functionality forms another aspect of the present invention. More particularly, the present invention provides, in another embodiment, an engine control unit (ECU) for controlling lubrication of a two stroke port injected engine comprising:

at least one input port to receive signals from engine sensors monitoring engine operating parameters;

a processing unit to determine engine operating conditions on the basis of sensed engine operating parameter signals; and

a fuel injection controller to control operation of the port injector to deliver lubricant to the engine wherein the fuel injection controller operates the port injector in accordance with a schedule of lubricating events determined as a function of engine operating conditions, by the engine control unit.

Advantage is gained from the method because by oil pump and like devices may be eliminated. This reduces cost, complexity and weight of the engine, critical advantages for high performance engines. Such engines are often employed in high performance off-road type motorcycles used for competition, such as in motocross events. In motocross, weight and robustness are of utmost importance with very high performance engines employed. The “drivability” of the engine is also very important in terms of negotiating and accelerating out of slow speed comers.

### BRIEF DESCRIPTION OF THE DRAWINGS

FIG. 1 is a cross section of an engine operated in accordance with the method of lubrication of one embodiment of the present invention.

### DETAILED DESCRIPTION

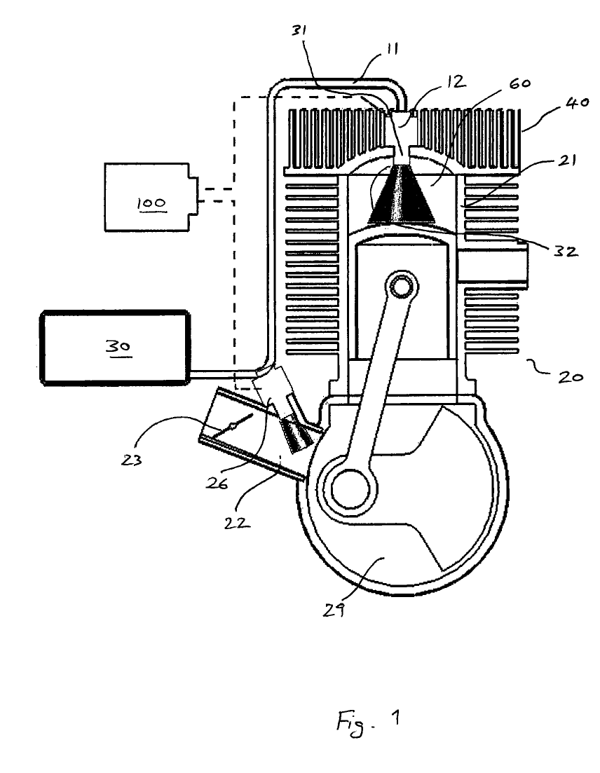

FIG. 1 shows cylinder 21 of a two stroke cycle internal combustion engine 20 which is a petroil engine, in which lubricant is mixed with fuel, stored in fuel tank 30, and excluding a dedicated lubrication system involving lubricant tanks, pumps and filters. Exclusion of such a lubrication system reduces weight of the engine 20 and this may be particularly advantageous in high performance engines.

The engine 20 is spark ignited and operated on a liquid fuel such as gasoline. The cylinder 21 has a combustion chamber 60, a cylinder head 40 and an air intake manifold 22. A fuel injector 26 is located in the air intake manifold 22, downstream of throttle 23, to inject the fuel into the air intake manifold 22 and then to crankcase 29 of engine 20. This injector 26 is a port injector of conventional type such as throttle body type. Engine 20 is a crankcase scavenged engine.

A fuel injector 12 is located in the cylinder head 40 of cylinder 21. Fuel injector 12 is a direct injector arranged to deliver fuel directly into the combustion chamber 60 of cylinder 21 alone or entrained in air or other gas. Fuel injector 12 has a housing 30 with a cylindrical spigot 31 defining an injection port 32 in communication with a fuel rail 11 described below. The injection port 32 includes a solenoid operated selectively openable poppet valve operating in a manner similar to that as described in the Applicant's U.S. Pat. No. 4,934,329, the contents of which are hereby incorporated by reference, and which relates to a dual fluid injection system. A fuel metering unit (not shown), as described in U.S. Pat. No. 4,934,329, is employed to meter the requisite quantities of fuel to direct fuel injector 12 through fuel rail 11. Direct injection from fuel injector 12, under low engine speed and load conditions, allows formation of a stratified charge and lean burn combustion with good combustion stability and emissions performance.

Engine 20 is lubricated with a two stroke lubricating oil which is pre-mixed with the gasoline at a desired ratio. This avoids the need for a separate lubrication system with associated pumps and other components. The ratio of gasoline to lubricant may be within the range of approximately 25:1 to 100:1. Additional additives may also be incorporated into the gasoline.

Lubrication of the engine 20 is achieved by operation of the port fuel injector 26 which opens to deliver lubricant (entrained in fuel) in accordance with determined lubrication requirements of the engine 20 over the engine operating engine load and speed range.

Operation of fuel injectors 12 and 26 is under control of an electronic control unit (ECU) 100 which controls the duration of the opening period or injection event of each fuel injector 12 and 26 as well as the timing of each fuel injector 12 and 26 event during an engine cycle. It will be understood that fuel injectors 12 and 26 need not, and likely would not, be operated simultaneously though this depends on engine operating conditions. For example, fuel injectors 12 and 26 likely would be operated simultaneously to enable augmentation of direct fuel injection by port injection under high engine speed, high engine load conditions particularly in high performance vehicles.

ECU 100 obtains input signals from various sensors, such as engine speed sensors, providing information on the operating conditions of engine 20 as well as the driver demand and outputs control signals to certain engine components. The driver demand can be determined either as a load demand or a speed demand depending on the engine control strategy used. For example, a determination of the driver demand may be obtained from a throttle position sensor which provides a driver demand input signal to the ECU 100. Numerous other sensors are used to provide information to ECU 100 on the operating conditions of the engine 20. For example, input port(s) of the ECU 100 receive input signals relating to the air temperature and the engine speed. The ECU 100 may also receive other inputs such as crankshaft position inputs (eg TDC pulses) depending on the particular engine application or configuration. Conversely, the ECU 100 outputs control signals to, for example, the electronic driver or fuel injection controller of the fuel injectors 12 and 26. A processing unit of ECU 100 then determines the engine operating conditions and, through use of look-up map(s), correlates these engine operating conditions with a pre-programmed schedule of lubrication events which the ECU 100 then implements. Alternatively, the processing unit may calculate the schedule of lubrication events based on the engine operating conditions.

Operation of engine 20, incorporating port and direct fuel injectors 12 and 26, will now be described. Under certain engine operating conditions, such as low engine speeds and loads, direct fuel injector 12 would typically supply the entire fuel requirement of engine 20. Such direct injection allows stable stratified charge, lean burn combustion. In an engine containing a distinct lubrication system, lubrication would be achieved by operating that system. Engine 20 excludes such a system yet lubrication is still required. In accordance with the invention, port injector 26 is operated to provide an appropriate amount of lubrication to the engine in accordance with a schedule of lubrication events. ECU 100 controls port injector 26 to operate accordingly while controlling direct fuel injection from fuel injector 12. Port injector 26 may be operated as many times as necessary in an engine operating cycle. In a lubrication only mode, port injector 26 might not be operated each engine operating cycle.

Specifically, ECU 100 controls lubrication of the engine 20 in this low engine speed, low engine load regime by actuating port injector 26 in discrete lubrication event(s), of controlled frequency, timing and duration to deliver lubricant to the engine 20 to meet lubrication requirements of the engine under such engine operating conditions.

However, the lubrication events of the port injector 26 still introduce fuel to the engine. Therefore, dependent on engine fuelling requirements, the amount of fuel metered and delivered by direct fuel injector 12 may be reduced to some extent by the ECU 100 to compensate and avoid over-fuelling or rich misfire of the engine 20. Opening events of direct fuel injector 12 may be varied in profile or duration, delayed or cancelled for the same reason. Alternatively, fuel injection events of direct fuel injector 12 may be scheduled differently around lubrication event(s). For example, such direct fuel injection event(s) may be of shorter duration or stopped altogether. PI events may be scheduled, timed or profiled to substitute for DI events during a lubrication phase. In any event, ECU 100 operates to avoid the over-fuelling or rich misfire situation. This may include control over operation of fuel injector 26. That is, even if a lubrication event is indicated according to the ECU 100 schedule of lubrication events, it may be omitted or varied, if a rich misfire or overfuelling situation is indicated.

Under engine operating conditions other than low engine speed, low engine load conditions, the port fuel injector 26 and direct fuel injector 12 may be actuated according to a control regime set by ECU 100 for such conditions. Again ECU 100 may schedule events of such injectors 12 and 26 through use of look-up maps adapted to the particular engine operating conditions.

Injectors 12 and 26 may be actuated simultaneously or with overlapping fuel injection events, if necessary, to deliver increased fuel and achieve more power output. This regime of operation includes the typical PI/DI regime of operation which is utilised to maximise engine power output particularly in high performance vehicles. At the same time, port injector 26 is operated in accordance with an ECU 100 controlled schedule of lubrication events to lubricate the engine 20.

In each case, ECU 100 determines the total fuel per cycle requirement of the engine 20 and the contribution, on a fuel per cycle basis, of each fuel injector 12 and 26, to this total fuel per cycle requirement. The fuel per cycle contribution of the direct injector 12 and, if necessary, the port injector 26 may be trimmed or varied as necessary to avoid over or under-fuelling of engine 20 which could otherwise be caused by introduction of lubricant admixed with the fuel.

Lubrication using a port injector 26 in a petroil type engine allows weight reduction and better design for high performance vehicles.

Modifications and variations to the method and control unit of the invention may be envisaged by the skilled reader of this disclosure. Such modifications and variations are within the intended scope of the invention. For example, the Applicant has developed an operating methodology in which port injection is preferred at high engine speed, high engine load regimes and direct injection at other times. The lubrication method of the present invention could be controlled to allow for appropriate lubrication with such operating methodology.

1. A method of lubricating a two stroke cycle fuel injected internal combustion engine having a port injection system for supplying fuel to said engine and comprising the steps of:
pre-mixing a lubricant with a fuel to form a fuel/lubricant mixture;
supplying the fuel/lubricant mixture to said port injection system having a port injector; and
controlling operation of said port injector to deliver the fuel/lubricant mixture to a crankcase of the engine for lubricating engine components in accordance with engine operating conditions.

2. The method of claim 1, wherein the fuel/lubricant mixture is supplied to a crankcase scavenged engine.

3. The method of claim 1, wherein the fuel and the lubricant are mixed at a pre-determined ratio.

4. The method of claim 1, wherein the fuel is injected to the engine by a direct injector of a direct fuel injection system.

5. The method of claim 4 wherein the direct fuel injection system injects fuel to the engine entrained in air.

6. The method of claim 4, wherein the engine is operated in spark ignited stratified charge lean burn combustion mode over at least part of the engine operating range.

7. The method of claim 1, wherein the port injector injects the fuel/lubricant mixture to the engine under high engine speed and high engine load conditions.

8. The method of claim 1, wherein the port injector injects the fuel/lubricant mixture to the engine outside a high engine speed and high engine load operating region.

9. The method of claim 8, wherein the port injector injects the fuel/lubricant mixture to the engine under low engine speed and low engine load conditions.

10. The method of claim 1 wherein the port injector is operated intermittently or periodically.

11. The method of claim 1 wherein the periodicity of port injector operation is set by an engine control unit in response to sensed engine operating conditions.

12. The method of claim 11 wherein the port injector is operated according to a schedule of lubrication events set by said engine control unit.

13. The method of claim 4, wherein an amount of fuel injected to the engine by said direct injection system is adjusted to compensate for additional fuel delivered by said port injector when delivering the fuel/lubricant mixture to lubricate said engine.

14. The method of claim 4, wherein the port injection system and the direct fuel injection system are operated simultaneously.

15. The method of claim 14, wherein injection events for the port injector and the direct injector are controlled dependent on engine operating conditions.

16. The method of claim 1, wherein the port injector is controlled by controlling at least one of a profile, a frequency, a timing and a duration of opening of the port injector.

17. The method of claim 14, wherein injection events for the port injector and the direct injector are controlled by controlling at least one of a profile, a frequency, a timing and a duration of opening of each injector.

18. The method of claim 4 wherein fuelling to the engine is calculated on a fuel per cycle basis and an engine control unit controls the fuel contribution made by the direct injector and the port injector to the fuel per cycle.

19. The method of claim 17 wherein an injection event for the direct injector is cancelled or delayed to avoid over-fuelling or rich mis-fire.

20. The method of claim 17, wherein an engine control unit calculates a schedule of events for the direct injector and the port injector dependent on engine operating conditions.

21. An engine control unit (ECU) for controlling lubrication of a two stroke port injected engine comprising:
at least one input port to receive a plurality of signals from a plurality of engine sensors monitoring engine operating parameters;
a processing unit to determine engine operating conditions on the basis of the plurality of signals; and
a fuel injection controller to control operation of a port injector to deliver a lubricant to the engine according to a schedule of lubricating events wherein the fuel injection controller operates the port injector in accordance with said schedule of lubricating events, the schedule of lubricating events being determined as a function of engine operating conditions.

22. The method of claim 5, wherein the engine is operated in spark ignited stratified charge lean burn combustion mode over at least part of the engine operating range.

23. The method of claim 4, wherein the port injector injects the fuel/lubricant mixture to the engine outside a high engine speed and high engine load operating region.

24. The method of claim 7, wherein the port injector injects the fuel/lubricant mixture to the engine outside the high engine speed and high engine load operating region.

25. The method of claim 23, wherein the port injector injects the fuel/lubricant mixture to the engine under low engine speed and low engine load conditions.

26. The method of claim 24, wherein the port injector injects the fuel/lubricant mixture to the engine under low engine speed and low engine load conditions.

27. The method of claim 5, wherein an amount of fuel injected to the engine by said direct injection system is adjusted to compensate for additional fuel delivered by said port injector when delivering the fuel/lubricant mixture to lubricate said engine.

28. The method of claim 5, wherein the port injection system and the direct fuel injection system are operated simultaneously.

29. The method of claim 28, wherein injection events for the port injector and the direct injector are controlled dependent on engine operating conditions.

30. The method of claim 28, wherein injection events for the port injector and the direct injector are controlled by controlling at least one of a profile, a frequency, a timing and a duration of opening of each injector.

31. The method of claim 30, wherein an injection event for the direct injector is cancelled or delayed to avoid over-fuelling or rich mis-fire.

32. The method of claim 30, wherein an engine control unit calculates a schedule of events for the direct injector and the port injector dependent on engine operating conditions.
